(19) United States
(12) Patent Application Publication
(10) Pub. No.: US 2021/0252430 A1
(43) Pub. Date: Aug. 19, 2021

(54) METHOD AND SYSTEM FOR EVACUATING AGGREGATES ACCUMULATED IN THE BOTTOM OF A TANK OF A DESALTER OR A DESANDER

(71) Applicant: ORTEC EXPANSION, Aix-en-Provence Cedex 3 (FR)

(72) Inventor: Daniel RIVARD, Paris (FR)

(21) Appl. No.: 17/173,280

(22) Filed: Feb. 11, 2021

(30) Foreign Application Priority Data
Feb. 13, 2020 (FR) 2001412

(51) Int. Cl. B01D 21/24; B01D 21/26

(52) U.S. Cl. CPC B01D 21/2472; B01D 21/2461; B01D 21/267

(57) ABSTRACT

The system for evacuating aggregates accumulated in the bottom of a tank of a desalter or desander. The tank may be provided with piping for evacuating aggregates provided with a diffuser/regulator cover and a water distribution ramp, including means for injecting into the tank, pressurized nitrogen via the piping for evacuating aggregates, a first very-high-pressure rod arranged in the piping for evacuating aggregates to inject water and a fluxing product at the level of the diffuser/regulator cover, a second very-high-pressure rod to inject at least water and a fluxing product above the water distribution ramp, and an evacuation device including the piping for evacuating aggregates, to evacuate the aggregates.

### CROSS REFERENCE TO RELATED APPLICATIONS

This application claims priority under 35 U.S.C. § 119 to French Patent Application No. 2001412, filed on Feb. 13, 2020, which is hereby incorporated by reference herein in its entirety.

### TECHNICAL FIELD

The present invention concerns a method and a system for evacuating aggregates accumulated in the bottom of a tank of a desalter or a desander.

### STATE OF THE ART

Although not exclusively, the present invention applies more specifically to desalters or desanders arranged on a Floating Production Storage and Offloading (FPSO) type unit. Such a floating unit corresponds to a floating vessel for drilling, treating and storing hydrocarbons at sea.

It is known that desanders and desalters installed on FPSO-type floating units comprise, generally, at least one tank (or vat) for treating crude oil of several tens of metres in length. This tank has the function of retaining the heaviest mineral particles, in order to clarify the crude oil.

Crude oil is brought through the bottom of the tank, to the centre of the length of the tank, via pipes to which are connected crude oil diffuser ramps. The role of these diffuser ramps is to diffuse crude oil to the top of the tank. These diffuser ramps are equipped with nozzles. These nozzles have a low flow rate. This low flow rate has the consequence of facilitating the deposit of heavy products (or aggregates) in the bottom of the tank. Crude oil is evacuated through the top of the tank, at the centre of it.

The bottom of the tank is divided into a plurality of compartments by partitions going up to the third of the tank. This arrangement has the effect of distributing in a relatively balanced manner, the deposits of aggregates over the length of the tank.

In the context of the present invention, by “aggregate” is meant any types of products deposited at the bottom of the tank, in particular heterogenic assemblies of substances or elements which adhere together, but also sand or other products.

In order to be able to evacuate the aggregates deposited in the bottom of the tank, generally an installation for resuspension is provided. This installation comprises, in a usual way, water distribution ramps, provided in each compartment. These ramps are provided with nozzles the function of which is to resuspend the aggregates and to direct them towards the outlet via an evacuation arranged in the lower portion under each compartment.

In order to be able to evacuate aggregates in a uniform manner over the length of each compartment and to avoid blockages of the evacuation piping, the latter is covered with an angle-shaped cover with inverted V-shaped notches on each side, and this, over the length of the angle. This cover operates such as a diffuser/regulator.

However, these installations do not make it possible to evacuate all of the aggregates deposited at the bottom of the tank, which regularly obliges the owner to completely stop the installations to empty the tank. Such a stop generates important operation losses.

### SUMMARY OF THE INVENTION

The present invention aims to overcome this disadvantage. It relates to a method for evacuating aggregates accumulated in the bottom of a tank of a desalter or desander, allowing an evacuation of all aggregates.

According to the invention, said method for evacuating aggregates accumulated in the bottom of a tank of a desalter or desander, said tank being provided with piping for evacuating aggregates and a water distribution ramp, the piping for evacuating aggregates being provided with a diffuser/regulator cover,

is noteworthy in that it comprises at least the following steps:

a first step consisting of injecting into the tank, at least pressurised nitrogen, by way of the piping for evacuating aggregates;

a second step consisting of injecting at least pressurised water at the level of the diffuser/regulator cover of the tank using a first very-high-pressure rod;

a third step consisting of injecting at least pressurised water above the water distribution ramp using a second very-high-pressure rod; and

a fourth step consisting of evacuating aggregates via said piping for evacuating aggregates.

Thus, in particular thanks to the first step which makes it possible in particular to decompress and resuspend the aggregates accumulated in the lower portion of the tank and the second and third steps which make it possible in particular to disaggregate the aggregates, said method makes it possible to facilitate the evacuation of most aggregates present at the bottom of the tank. The evacuation method thus makes it possible to overcome the abovementioned disadvantages.

Advantageously, the second step consists of also injecting a fluxing product into the tank.

Furthermore, advantageously, the third step consists of rotating an injection head of the second very-high-pressure rod. In addition, advantageously, the third step consists of also injecting a fluxing product into the tank.

Moreover, advantageously, the fourth step consists of subjecting the aggregates to a physical liquid/solid separation operation. Advantageously, the liquid portion obtained by the physical liquid/solid operation, is injected into the tank via the water distribution ramp.

The present invention also concerns a system for evacuating aggregates accumulated in the bottom of a tank of a desalter or desander, said tank being provided with piping for evacuating aggregates and a water distribution ramp, the piping for evacuating aggregates being provided with a diffuser/regulator cover.

According to the invention, said evacuating system comprises at least:

means for injecting into the tank, at least pressurised nitrogen via the piping for evacuating aggregates;

at least one first very-high-pressure cover arranged in the piping for evacuating aggregates and configured to inject at least water at the level of the diffuser/regulator cover of the tank;

at least one second very-high-pressure rod configured to inject at least water above the water distribution ramp; and

an evacuation device comprising the piping for evacuating aggregates, configured to evacuate said aggregates.

Advantageously, the first very-high-pressure rod is provided with a head provided with nozzles, said head being configured to be able to be rotated manually.

Furthermore, advantageously, at least one of said first and second very-high-pressure rods comprises a plurality of successive individual sections.

In a preferred embodiment, the second very-high-pressure rod is arranged in a pipe of the water distribution ramp and comprises a head which passes through the water distribution ramp to the top. Advantageously, the evacuation system comprises means for automatically rotating the head of the second very-high-pressure rod.

Moreover, in a preferred embodiment, the evacuating device comprises a liquid/solid separation system.

Advantageously, the liquid/solid separation system is provided:

with at least two hydrocyclones mounted in series; and/or

with a hopper the bottom of which is equipped with a worm screw.

Furthermore, advantageously, the liquid/solid separation system is provided with means for injecting a liquid portion produced by said separation system, into the tank via the water distribution ramp.

### BRIEF DESCRIPTION OF THE FIGURES

The appended figures will make it well understood how the invention can be achieved. In these figures, identical references designate similar elements.

FIG. 1 is a schematic view of a tank provided with a system for evacuating aggregates.

FIG. 2 schematically illustrates the main steps of a method for evacuating aggregates.

FIG. 3 is a cross-sectional view of a very-high-pressure rod arranged in a pipe of a water distribution ramp, the head of which opens into the tank.

FIG. 4 is a cross-sectional view of a system for boring a hole in the water distribution ramp.

### DETAILED DESCRIPTION

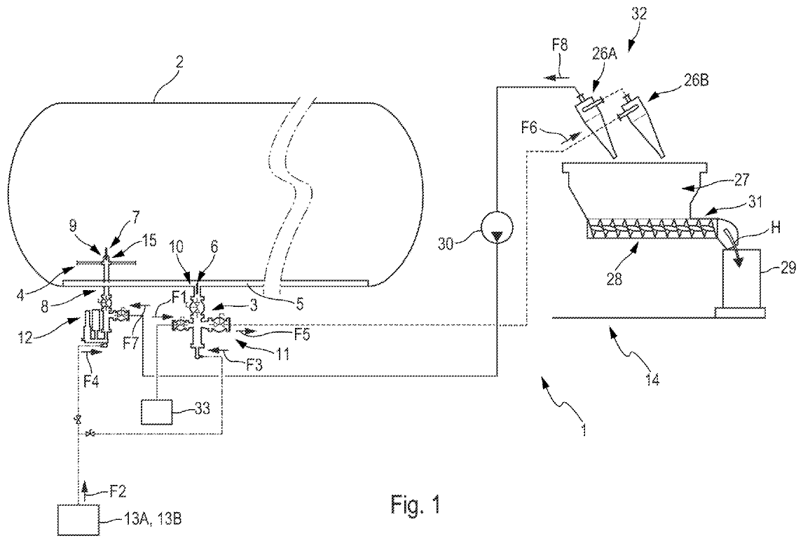

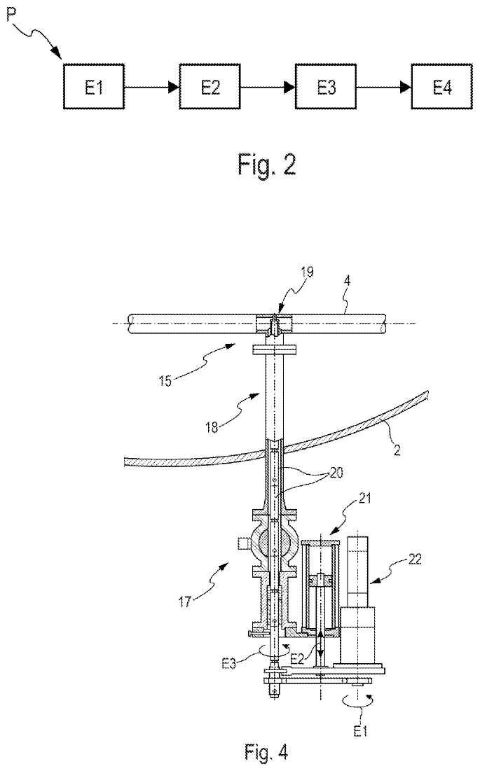

The method P illustrating the invention and schematically represented in FIG. 2 is a method for evacuating aggregates accumulated in the bottom of a tank 2 (FIG. 1) of a desalter or desander, allowing an evacuating of all of the aggregates accumulated in the bottom of this tank 2.

Although not exclusively, the present invention is applied more specifically to desalters or desanders arranged on a Floating Production Storage and Offloading (FPSO) type unit. Such a floating unit corresponds to a floating vessel for drilling, treating and storing hydrocarbons at sea.

It is known that desanders and desalters installed on FPSO-type floating units comprise, generally, at least one tank 2 for treating crude oil. This tank 2 has the function of retaining the heaviest mineral particles, in order to clarify the crude oil.

The tank 2 is provided with piping for evacuating aggregates 3 which forms part of an evacuation device 11 and water distribution ramps 4 which form part of a water distribution system 12 (sand-jetting). The piping 3 for evacuating aggregates is provided with a diffuser/regulator cover 5.

Crude oil is brought via the bottom of the tank 2, to the centre of the length of the tank 2, via a piping to which are connected crude oil distribution ramps. Crude oil is evacuated via the top of the tank 2, at the centre of the latter. The means for bringing crude oil into the tank and for evacuating it are known and are not described further.

In order to be able to evacuate the aggregates in a uniform manner and to avoid blockings of the evacuation piping 3, the latter is therefore covered by the cover 5. In a preferred embodiment, the cover 5 is angle-shaped with inverted V-shaped notches on each side, and this over the length of the angle. This cover 5 operates such as a diffuser/regulator.

The method P for evacuating aggregates accumulated in the bottom of the tank 2 comprises at least the following steps, represented schematically in FIG. 2:

a step E1 consisting of injecting into the tank 2, at least pressurised nitrogen by way of the evacuation piping 3, as illustrated by an arrow F1 in FIG. 1, in order to decompress and resuspend the aggregates accumulated in the lower portion of the tank 2. To do this, a nitrogen flow is injected, using a nitrogen injection system 33, under 7 to 8 bars, for a few minutes, via the evacuation piping 3;

a step E2 consisting of injecting at least pressurised water at the level of the diffuser/regulator cover 5 of the tank 2, from a water tank 13A, as illustrated by the arrows F2 and F3. This injection is done using a very-high-pressure rod. To do this, a VHP (very-high-pressure) rod 6 is introduced, through the centre of the evacuation piping 3. The VHP rod 6 goes up to the inside of the diffuser/regulator cover 5, in order to unclog the latter with a flow rate of 60 litres per minute under 700 bars. Preferably, a fluxing product is also injected (coming from a tank 13B) additionally, in order to allow better evacuation of the aggregates through the evacuation piping 3;

a step E3 consisting of injecting at least pressurised water above the water distribution ramp 4 using a VHP rod 7 from the water tank 13, as illustrated by the arrows F2 and F4. To do this, the VHP rod 7 is introduced via the piping 8 for accessing the water distribution ramp 4. The VHP rod 7 exits above the distribution ramp 4 and supplies a VHP rotating head 9, with a flow rate of 60 litres per minute under 700 bars. The jets from the VHP head 9 are generated to disaggregate the aggregates, in order to facilitate their evacuation via windows arranged all along the cover 5 disposed above the evacuation piping 3. Preferably, a fluxing product is also injected (coming from the tank 13B) to facilitate the flow; and

a step E4 consisting of evacuating the aggregates which are disaggregated and fluxed, via said evacuation piping 3, as illustrated by an arrow F5. The step E4 also consists of subjecting the aggregates evacuated, to a physical liquid/solid separation operation, and the liquid portion obtained by the physical liquid/solid separation, is injected into the tank 1 via the water distribution ramp 4 of the water distribution system 4, as illustrated by an arrow F7.

The fluxing product makes it possible, in particular, to favour a separation of at least some of the components of the aggregates, in particular between the hydrocarbons and the sediments present in the aggregates.

The aggregates which are disaggregated and fluxed in order to make them fluid are pushed by the internal pressure of the tank 2 and are directed towards a physical liquid/solid separation system (here-after, “separation system 14”).

The combination of the steps E1 to E4 of the method P makes it possible to facilitate the evacuation of most of the aggregates present at the bottom of the tank, in particular thanks to the step E1 which makes it possible, in particular, to decompress and resuspend the aggregates accumulated in the lower portion of the tank and in the steps E2 and E3 which makes it possible, in particular, to disaggregate the aggregates in two different places.

The method P, such as described above, is implemented by a system 1 for evacuating aggregates, such as represented in FIG. 1.

This evacuation system 1 comprises at least:

a system 33 for injecting into the tank 2, pressurised nitrogen, via the evacuation piping 3;

the VHP rod 6 arranged in the evacuation piping 3 and configured to inject water and the fluxing product at the level of the diffuser/regulator cover 5 of the tank 2;

the VHP rod 7 configured to inject water and the fluxing product above the water distribution ramp 4 and therefore above the cover 5; and

the evacuation device 11 comprising the evacuation piping 3, which is configured to evacuate the aggregates.

Here-under is described, in more detail, the method P and the system 1.

For introducing nitrogen and the VHP rod 6 via an aggregate evacuation valve, the following can be provided:

to place a cross directly under the evacuation valve. On this cross and on one of the perpendicular portions, the extraction of the aggregates is carried out. This perpendicular evacuation is isolated by another valve;

to place another valve on the second perpendicular outlet of the cross. This makes it possible to inject at the perpendicular of the piping, pressurised nitrogen of 7 bars to 8 bars. The aim is to resuspend the aggregates. This injection is carried out for a few minutes. An auxiliary valve makes it possible to isolate the input of the nitrogen.

Under the cross, by extending the outlet piping, the VHP rod 6 is installed at the centre. The latter goes up through the cross and a protective valve.

This VHP rod (or tube) 6 opens inside the tank 2, in the middle of the angle-shaped cover 5.

At the end of this VHP rod 6, a head 10 (provided with four nozzles disposed perpendicularly to the head 10), aims to dissociate the aggregates with a flow rate of 60 litres per minute under a pressure of 700 bars. This head 10 can be rotated manually, over 360°, in order to be totally effective for the exiting of the aggregates.

To respond to the low ground clearance, this VHP rod 6, is constituted, for its introduction, of several successive individual sections, for example 25 centimetres in length. It can, at any time, be removed with an isolation valve. A blocking system on this VHP rod 6 allows for the depositing and the placement of sections. At this level, the fluxing product is also injected, which facilitates the evacuation of the aggregates.

Moreover, in a preferred embodiment, the VHP rod 7 is arranged in a pipe 8 of the water distribution ramp 4 and comprises a head 9 which passes through the water distribution ramp 4 towards the top. The water distribution system 12 comprises means for automatically rotating the head 9 of the VHP rod 7.

The VHP rod 7 and its head 9 are introduced through the pipeline of the water distribution system 12 (sand-jetting) so that the head 9 opens just above the distribution ramp 4 of said water distribution system 12.

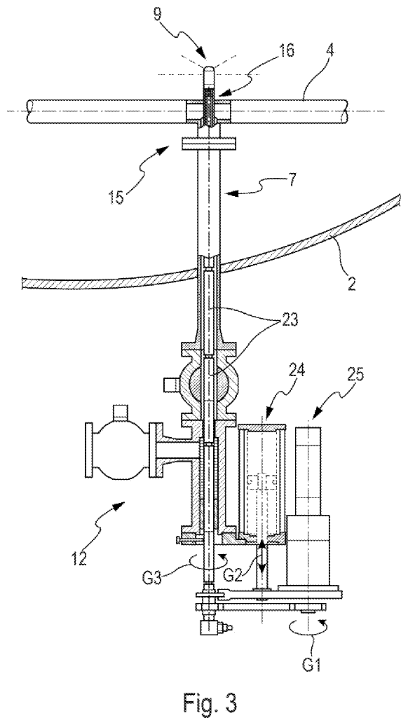

To make the head 9 exit via the piping above a mechanical Tee 15 of the water distribution system 12, as represented in FIG. 3, a hole 16 has to be bored (or drilled) beforehand, for example of 30 millimetres in diameter, in the distribution mechanical Tee 15 of the distribution ramp 4 of the water distribution system 12, and this, by having the piping under pressure at 7 bars.

To do this, the following method is implemented:

a drilling system 17 is installed under the outer valve of the water distribution system 12, comprising as represented in FIG. 4:
a system for guiding and sealing a drilling rod 18; and
the drilling rod 18 the end of which carries a drill bit, guided in its centre, by a drill 19.
   This drilling rod 18 is constituted of sections 20, for example of 25 centimetres, which are interlocked, by male/female screwing, one to the ends of the others. A retaining system allows the screwing and the unscrewing of the sections 20, as well as the holding in vertical position linked to the pressure exerted at 7 bars on the rod of the drill bit. A clip prevents any loosening of the sections 20;

the rotation of the vertical raising of the drill bit are implemented thanks to a pneumatic actuator 21 and a pneumatic motor 22, as illustrated by the arrows E1, E2 and E3; and

once the hole 19 is bored, it all is deposited and the valve of the water distribution system is closed as soon as the drill bit passes below said valve.

This drilling operation is only to be carried out once, during the first pressurised draining.

Once this drilling is carried out, the VHP rod 7 is installed on the water distribution system 12, as represented in FIG. 3. In this FIG. 3, a pneumatic system 24 is also represented for the vertical movement and a pneumatic motor 25 to generate a rotation. The different movements are highlighted by arrows G1, G2 and G3.

In a particular embodiment, it is provided that a mechanical Tee is installed under the valve of the water distribution system, capable of:

carrying on a perpendicular outlet of the mechanical Tee, a valve for supplying water, by which the water distribution ramp 4 of the water distribution system 12 continues to be supplied;

carrying below and in the axis of the mechanical Tee, the following elements:
a sealing system of the VHP rod 7, capable of ejecting 60 litres per minute under 700 bars. This VHP rod 7 is also made by sections 23 (FIG. 3), for example, of 25 centimetres;
a system for blocking the rail for the screwing/unscrewing;
the pneumatic system 24 for the vertical movement;
the system for rotating by pneumatic motor 25, of the VHP rod 7 of 0 to 50 rotations per minute; and
the VHP head 9 which has the role of making fluid the aggregates stored in the bottom of the tank 2.

Moreover, the liquid/solid separation system 14, is provided as represented in FIG. 1:

an assembly 32 of two hydrocyclones 26A and 26B mounted in series which receive the aggregates evacuated by the evacuation device 11, as illustrated by the arrows F5 and F6. The solid/liquid assembly is directed and conveyed thanks to the internal pressure of the tank 2 towards the assembly 25 of hydrocyclones 26A and 26B mounted in series. These hydrocyclones 26A and 26B are intended to generate a physical liquid/solid separation; and

a hopper 27 the bottom 31 of which is equipped with a worm screw 28.

The solid portion, coming from the separation implemented by the assembly 25, falls into the hopper 27, the bottom 31 of which is equipped with the worm screw 28. The role of the worm screw 28 is to wring the aggregates and make them exit from the hopper 27, by pushing them into a barrel 29 (as illustrated by an arrow H) which is then stored on the ground.

The liquid portion, coming from the separation implemented by the assembly 25, is directed, again, to the water distribution system 12, thanks to a volumetric pump 30, as illustrated by the arrows F8 and F7, in order to continue to dilute the aggregates and thus avoid uselessly manufacturing polluted liquids.

The system 1 is therefore provided with means for injecting the liquid portion produced by the separation system 14, into the tank 2 via the water distribution ramp 4.

As an illustration, the following can also be provided on the desander or the desalter:

an assembly, installed for example in a container, to supply energy to drive the VHP pump, the positive displacement pump 30, the worm screw 28 (for wringer and filling barrels 29), and a pump for dosing the fluxing product; and

a VHP unit, driven hydraulically and also installed in a container, with the vat 13A for supplying clean water, the vat 13B of fluxing product and the pump for dosing the fluxing product.

In the application of a particular tank 2, the bottom of which is divided into a plurality of compartments by partitions going up, for example, to the third of the tank 2, in particular to distribute in a relatively balanced manner, the deposits of the aggregates over the length of the tank 2, nitrogen, water and fluxing product injection means are provided, such as those described above, at the level of each of the different compartments of the tank.

1. A method for evacuating aggregates accumulated in the bottom of a tank of a desalter or desander, said tank being provided with piping for evacuating aggregates and a water distribution ramp, the piping for evacuating aggregates being provided with a diffuser/regulator cover, wherein the method comprises:
a first step comprising injecting into the tank, at least pressurized nitrogen by way of the piping for evacuating aggregates;
a second step comprising injecting at least pressurized water at the level of the diffuser/regulator cover of the tank using a first very-high-pressure rod;
a third step comprising injecting at least pressurized water above the water distribution ramp using a second very-high-pressure rod; and
a fourth step comprising evacuating the aggregates via said piping for evacuating aggregates.

2. The method according to claim 1,
wherein the second step further comprises injecting a fluxing product into the tank.

3. The method according to claim 1, wherein the third step comprises rotating a head for injecting the second very-high-pressure rod.

4. The method according to claim 1, wherein the third step further comprises injecting a fluxing product into the tank.

5. The method according to claim 1,
wherein the fourth step comprises subjecting the aggregates to a physical liquid/solid separation operation.

6. The method according to claim 5,
wherein the liquid portion obtained by physical liquid/solid separation, is injected into the tank via the water distribution ramp.

7. A system for evacuating aggregates accumulated in the bottom of a tank of a desalter or desander, said tank being provided with piping for evacuating aggregates and a water distribution ramp, the piping for evacuating aggregates being provided with a diffuser/regulator cover, wherein the system comprises:
means for injecting into the tank, at least pressurized nitrogen via the piping for evacuating aggregates;
at least one first very-high-pressure rod arranged in the piping for evacuating aggregates and configured to inject at least water at the level of the diffuser/regulator cover of the tank;
at least one second very-high-pressure rod configured to inject at least water above the water distribution ramp; and
an evacuating device comprising the piping for evacuating aggregates, configured to evacuate said aggregates.

8. The system according to claim 7,
wherein the first very-high-pressure rod is provided with a head provided with nozzles, said head being configured to be able to be rotated manually.

9. The system according to claim 7, wherein at least one of said first and second very-high-pressure rods comprises a plurality of successive individual sections.

10. The system according to claim 7, wherein the second very-high-pressure rod is arranged in a pipe of the water distribution ramp and comprises a head which passes through the water distribution ramp to the top.

11. The system according to claim 10,
further comprising means for automatically rotating the head of the second very-high-pressure rod.

12. The system according to claim 7, wherein the evacuation device comprises a liquid/solid separation system.

13. The system according to claim 12,
wherein the liquid/solid separation system is provided with at least two hydrocyclones mounted in series.

14. The system according to claim 12, wherein the liquid/solid separation system is provided with a hopper the bottom of which is equipped with a worm screw.

15. The system according to claim 12, wherein the liquid/solid separation system is provided with means for injecting a liquid portion produced by said liquid/solid separation system, into the tank via the water distribution ramp.
